(19) United States
(12) Patent Application Publication
(10) Pub. No.: US 2014/0321658 A1
(43) Pub. Date: Oct. 30, 2014

(54) Wireless Audio System

(71) Applicant: Ketan S. Rahangdale, Tallahasse, FL (US)

(72) Inventor: Ketan S. Rahangdale, Tallahasse, FL (US)

(21) Appl. No.: 13/869,397

(22) Filed: Apr. 24, 2013

(51) Int. Cl. H04R 1/00

(52) U.S. Cl. CPC H04R 1/00
USPC 381/71.1; 381/334

(57) ABSTRACT

A wireless audio system is provided which incorporates a main device and a holder, for use with a listening device and an audio output device. The main device is capable of connecting wirelessly to an audio output device and generally includes a chip for sound transmission, a series of controls to command audio output device and a port. The holder connects to and receives an audio transmission from the main device at port. The holder transmits the audio received to an external listening device via a second connector.

### BACKGROUND OF THE INVENTION

1. Field of the Invention

This invention relates to the field of electronic audio transmission systems. More specifically, the invention comprises a wireless device for audio and telephone communications configured to attach to prior art listening devices.

2. Description of the Related Art

Headphones typically include wires which connect to a signal source such as a radio, portable media player or mobile phone. Connector wires are generally 3.5 mm phone connectors used to transmit analog signals, primarily audio. High quality headphones include a 3.5 mm audio jack input point (or audio socket). A phone connector audio jack is inputted into an audio socket and connected to an output source providing a pathway for sound to the headphones.

The prior art changed dramatically when wireless communication eliminated the need for a connection via an electrical conductor. A wireless system uses some form of energy to transfer information without the use of wires. For example, a wireless transmission can be effected through radio waves, light waves, sound waves or magnetic or electric fields. Bluetooth®, a wireless technology standard developed, owned and managed by Bluetooth Special Interest Group, is one example of a connection system which uses radio technology to transmit audio. A Bluetooth® enabled mobile phone is capable of “pairing” with other devices. This connectivity allows the mobile phone to establish a two-way connection with another device. The phone and respective paired device or devices can freely exchange data at any time as long as the device is within a particular range or distance from one another.

There are many devices which use wireless transmissions to communicate. For example, remote controls, radios, cellular telephones and GPS devices all can operate wirelessly. Prior art wireless headphones include a receiver built into the headphones to receive a signal from a transmitter connected to an audio source. The headphones are either extremely expensive, deliver poor sound quality or require additional hardware, such as a bulky transmitter. The user must purchase the headphones and cease use of other high quality wired headphones that the user may already own. Additionally, the wireless headphones typically do not include an audio socket for a hard wire connection if desired and cannot be used in connection with other listening devices, such as a car stereo.

The present invention seeks to resolve these issues by providing an audio system which is capable of modifying a variety of existing listening devices in order to operate wirelessly. In addition, it is preferable to provide a device which is sleek in design, operates by a simple touch and syncs with a mobile phone. The present invention achieves these objectives, as well as others that are explained in the following description.

### BRIEF SUMMARY OF THE INVENTION

The present invention comprises a wireless audio system for use with an existing listening device, wherein the system provides a main device and a holder which are capable of wirelessly connecting to a prior art audio output device. The main device includes wireless capability in order to connect to (or pair with) an existing, audio output device, such as a mobile phone. The holder connects to the main device by way of a port, preferably a mini USB port, and includes the capability of connecting to an existing listening device, such as a pair of headphones, an auxiliary input in a car stereo or a speaker system.

The main device (connected to the holder) establishes a wireless connection with an audio output device such that the main device can wirelessly send commands and receive commands from the audio output device. The audio received from the audio output device is transmitted by main device through holder to a prior art listening device connected to holder. The main device can adjust signal gain to match impedance of the listening device that it plugs into, thus achieving high quality sound transmission.

In order to control audio output device, the main device includes a series of controls. In the preferred embodiment, controls are located on the front panel of the main device, which is a capacitive touch screen. A universal control is provided which can be programmed to operate the initiation of pairing the main device with the audio output device, to play music and to answer a phone call, play or stop music. The main device also incorporates a chip which includes an audio codec and two noise-cancelling microphones. Thus, the present system can modify an existing listening device in order to operate wirelessly through an audio output device.

### BRIEF DESCRIPTION OF THE SEVERAL VIEWS OF THE DRAWINGS

FIG. 1 is a perspective view, showing the present system.

FIG. 2 is a perspective view, showing the main device of the present system.

FIG. 3 is a perspective view, showing the main device of the present system.

FIG. 4 is a perspective view, showing the holder of the present system.

FIG. 5 is a perspective view, showing the main device and the holder of the present system aligned to be connected together.

FIG. 6 is a perspective view, showing the main device and the holder connected together.

FIG. 7 is a perspective view, showing the main device and the holder connecting to a prior art listening device.

FIG. 8 is a perspective view, showing the main device and the holder attached to a prior art listening device.

FIG. 9 is a perspective view, showing the main device and the holder connected together for use with an auxiliary mount.

FIG. 10 is a perspective view showing the main device and the holder connected together for use with a home audio mount.

REFERENCE NUMERALS IN THE DRAWINGS

| | | | |
|---|---|---|---|
| 10 | wireless audio system | 12 | holder |
| 14 | main device | 16 | second connector |
| 18 | universal control | 20 | volume |
| 22 | volume | 24 | fast forward |
| 26 | rewind | 28 | front panel |
| 30 | port | 32 | support |
| 34 | channel | 36 | first connector |
| 38 | stem | 40 | cup |
| 42 | headphones | 44 | audio socket |
| 46 | audio connection point | 48 | LED lights |
| 50 | audio output device | 52 | listening device |
| 54 | signals | 56 | microphone |
| 58 | main body | 60 | main portion |
| 62 | series of controls | | |

### DETAILED DESCRIPTION OF THE INVENTION

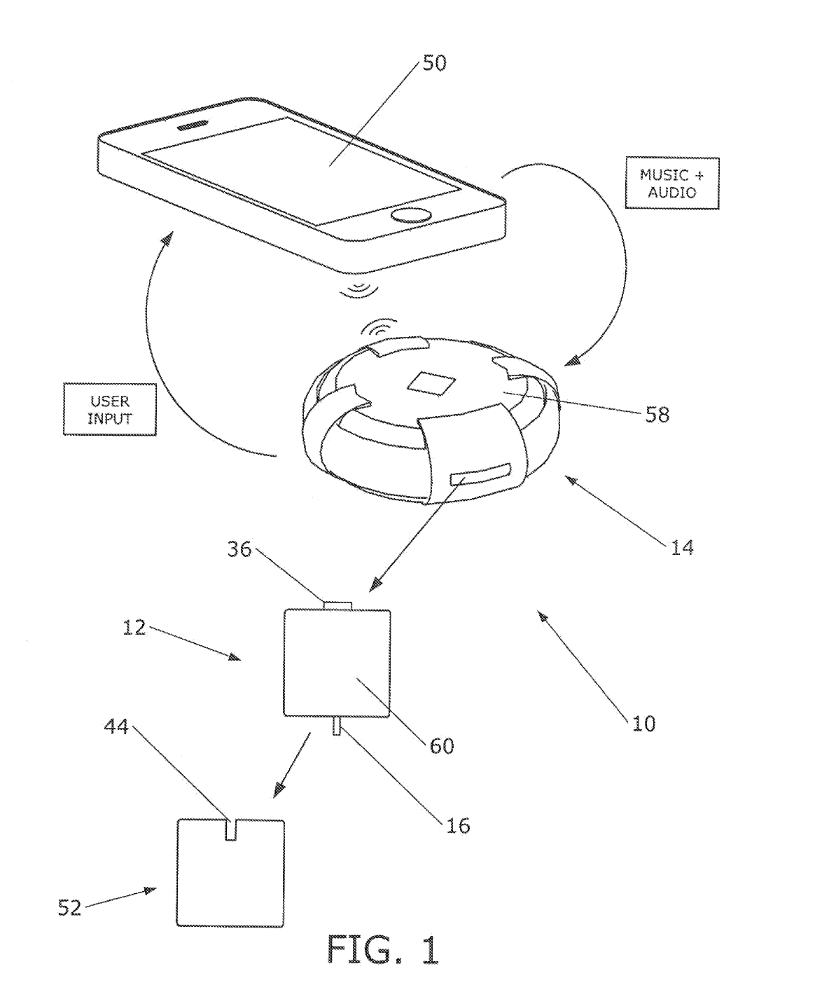

The present invention is a wireless audio system, for use with an existing listening device. As illustrated in FIG. 1, the present wireless audio system 10 is comprised primarily of a main device 14 and a holder 12. Main device 14 includes the capability of connecting wirelessly to an audio output device 50, such as a mobile phone. Holder 12 has the capability to connect to an existing listening device 52, such as a pair of headphones, an auxiliary input in a car stereo or a speaker system. Main device 14 establishes a wireless connection with audio output device 50 wherein main device 14 can send commands to control audio output device 50 while audio output device 50 can send audio to main device 14. The connection or “pairing” of devices is preferably accomplished with a wireless packet-based connection protocol such as Bluetooth®. Main device 14 syncs to an audio output device 50 such as a mobile phone, which is depicted as signals 54. Once paired, main device 10 and audio output device 50 communicate in a master/slave model of communication, in which the devices switch roles between master and slave at any given time, as is known in the prior art. Thus, the user can control audio output device 50 through main device 14 or vice versa. Main device 14 connects to holder 12, a charging device or a computing device, through a direct connection port 36, preferably a micro USB port, and outputs audio to holder 12 which is transmitted through a first connector 16 to a prior art listening device 52. Main device 14 can adjust signal gain to match impedance of the listening device 52 (e.g. headset) that it plugs into. This feature allows it to achieve high quality sound transmission.

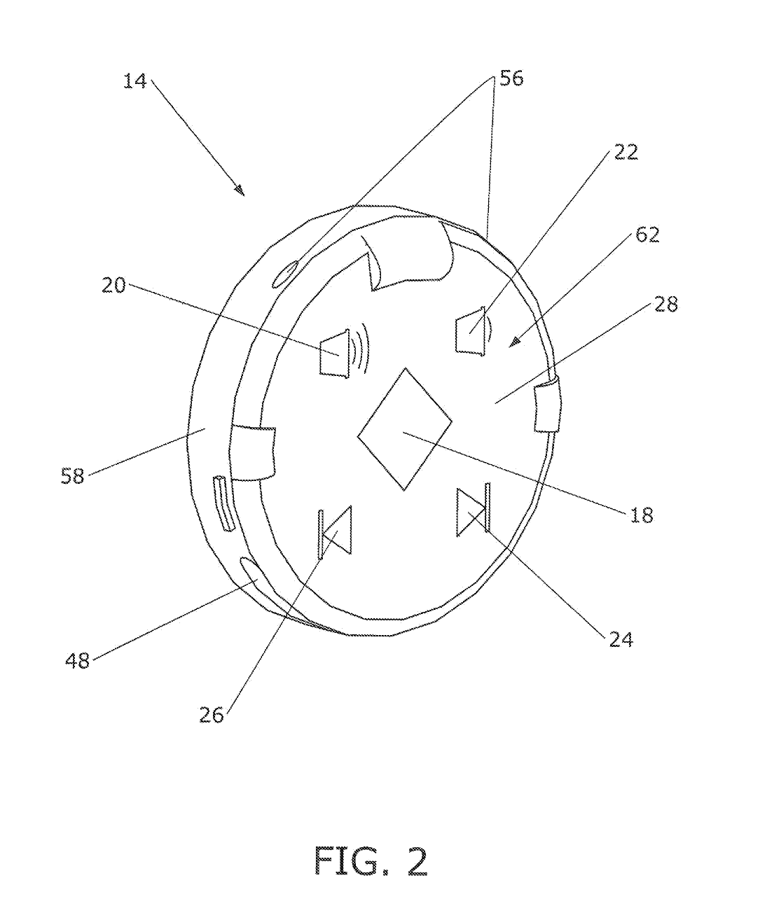

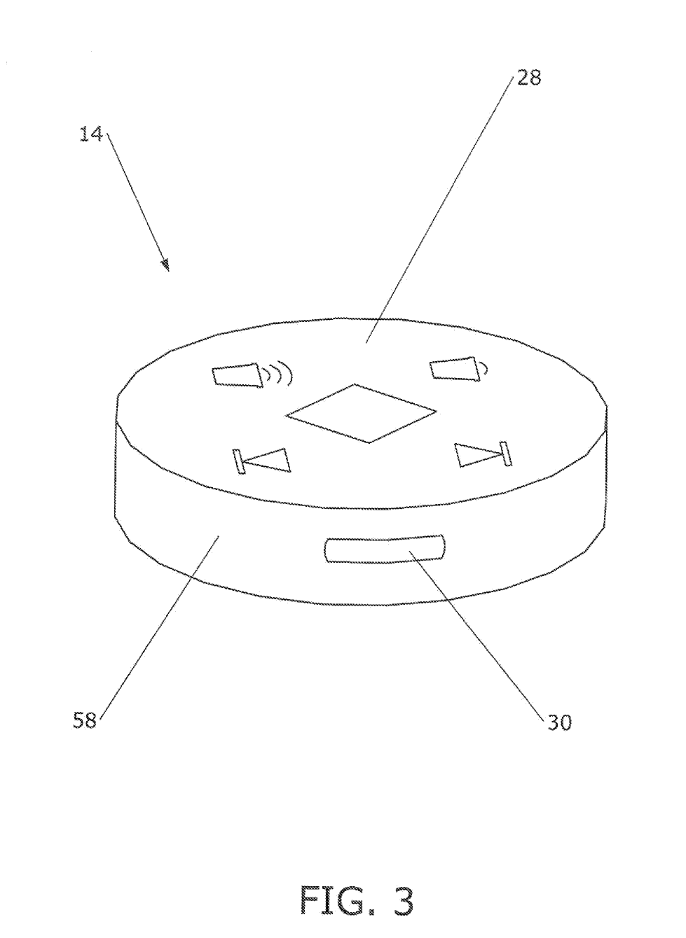

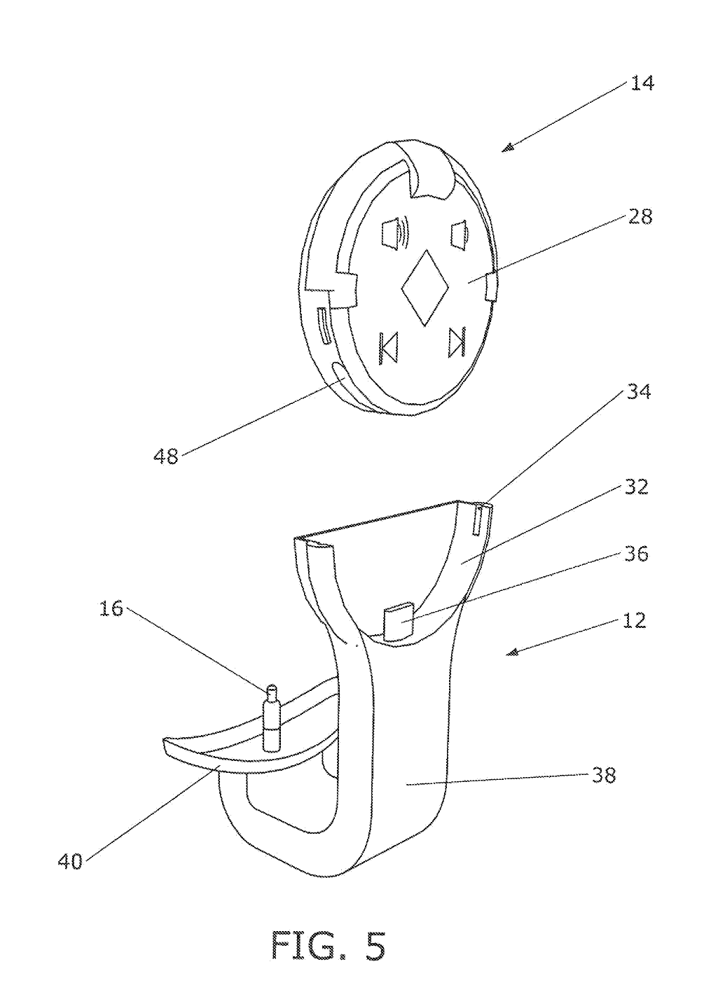

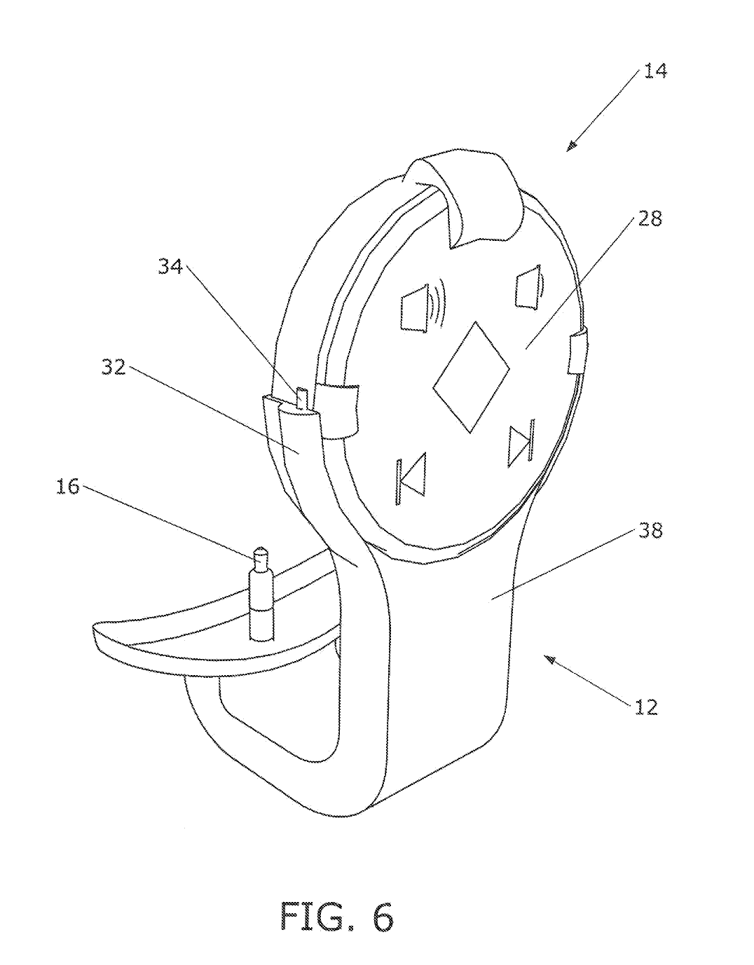

In FIG. 2, main device 14 is illustrated. Main device 14 must be capable of syncing with audio output device 50 (illustrated in FIG. 1). The user remotely operates audio output device 50. Controlling audio output device 50 can be accomplished by any known method. Thus, the controlling functionality can be achieved by voice activated commands, simple buttons or a capacitive touch screen. In the preferred embodiment, main device 14 includes a capacitive touch screen on front panel 28 of main body 58. A series of controls 62 are located on front panel 28, including, for example, volume up 20, volume down 22, rewind 26 and fast forward 24. A universal control 18 is in the center of front panel 28 and can be programmed to operate the initiation of pairing main device 14 with audio output device 50, to play music and to answer a phone call, play or stop music. Main device 14 incorporates a chip (or sound card) within main body 58 which includes an audio codec to achieve high-quality stereo/mono audio streaming. As an example Apt-X® codec, developed by CSR Plc., registered company of Cambridge, England, can be used as the digital audio data reduction technology which delivers high quality stereo audio via main device 14. The reader will appreciate that any known chip having similar capabilities can be used. Two noise-cancelling microphones, one in the main body and one in the holder, 56 are provided on main body 58 of main device 14. The microphones provide a mechanism for both audio transmission through the listening device and receiving audio from the source, such as the user's voice for transmission back to the audio output device (for example during a phone call). The two microphone system reduces ambient noise from the desired sound for a higher quality sound output through listening device. Additionally, microphone in the holder 56 provides for a primary microphone (closer to the user's mouth) for a user to speak into during a phone call while the secondary microphone receives ambient noise to cancel out the ambient noise and retain the desired sound. Optional LED lights 48 can be added to the edge of main device 14 to provide a sleek design. As shown in FIG. 3, main device 14 includes a port 30. Port 30 is preferably a micro USB port. However, the port 30 should not be limited to a micro USB port. Port 30 can he used to connect to holder 12 (as illustrated in FIGS. 5 and 6), a charger device or a computing device. Thus, main device 14 can be charged for use or can download new software via port 30.

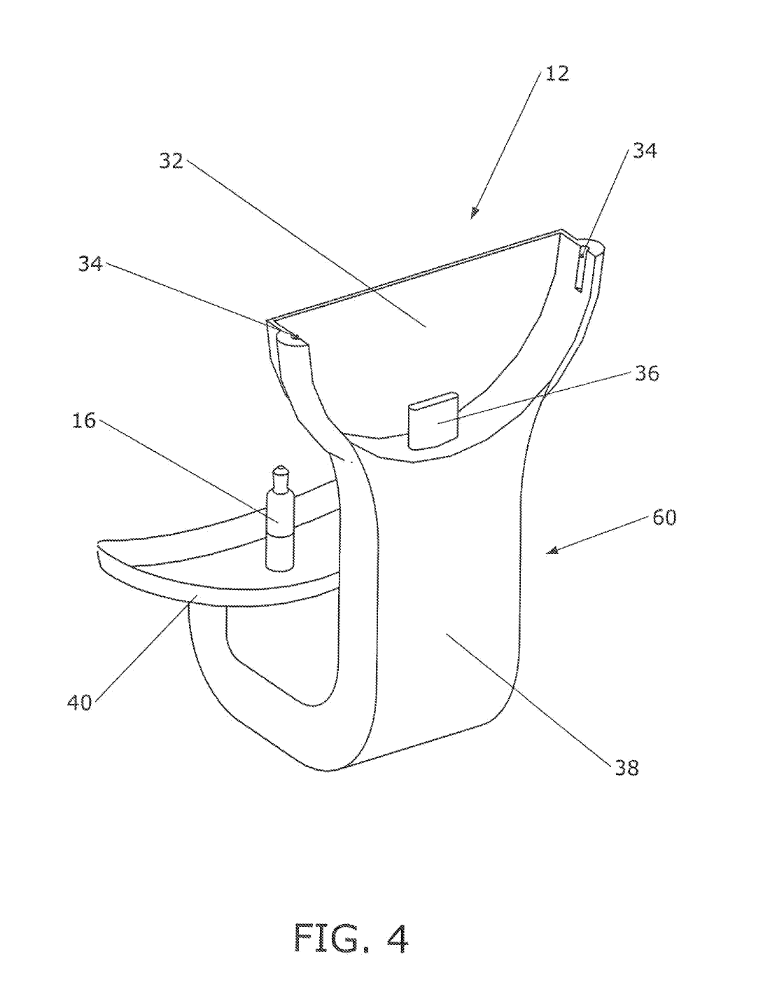

FIG. 4 illustrates holder 12, generally including a main portion 60, first connector 36 and a second connector 16. Main portion 60 is comprised of support 32 and stem 38. In the present embodiment, holder 12 includes a mini USB port as first connector 36 at support 32. Support 32 is fully integrated with stem 38 which connects to cup 40. Cup 40 is designed to form to the edge of headphones and includes second connector 16 which is an audio jack in the preferred embodiment.

The manner in which main device 14 and holder 12 connect together is shown in FIG. 5, by way of a broken line. Main device 14 fits onto first connector 36. As shown, channel 34 is located on both sides of support 32 which is designed to secure and cradle main device 14. Holder 12 and main device 14 in a connected position is depicted in FIG. 6. As described, support 32 including channel 34 ensures that main device 14 is securely attached to holder 12.

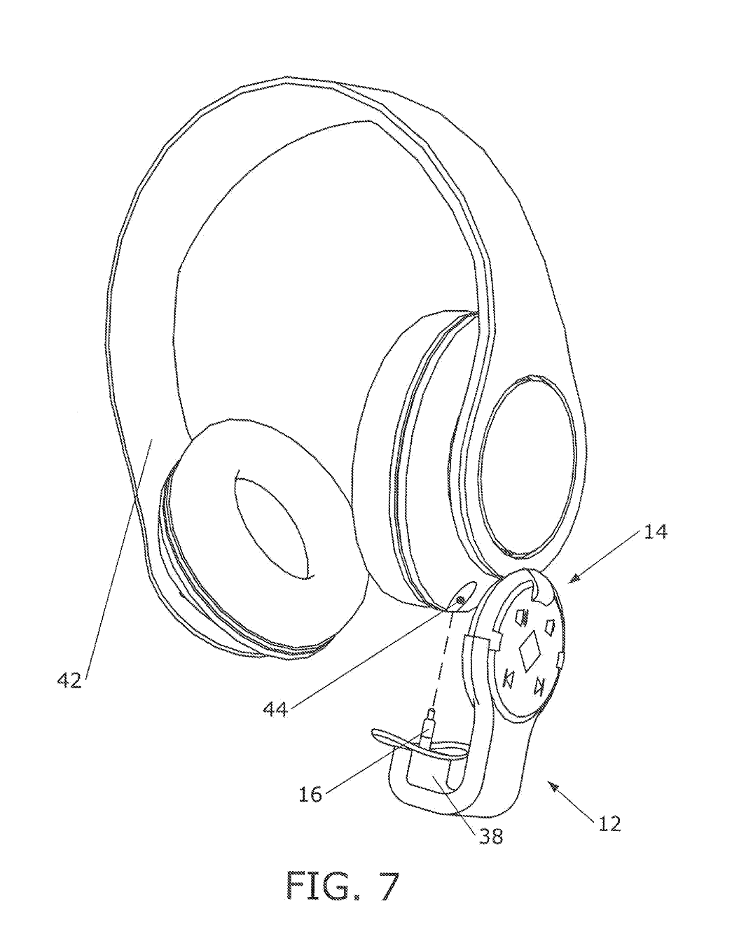

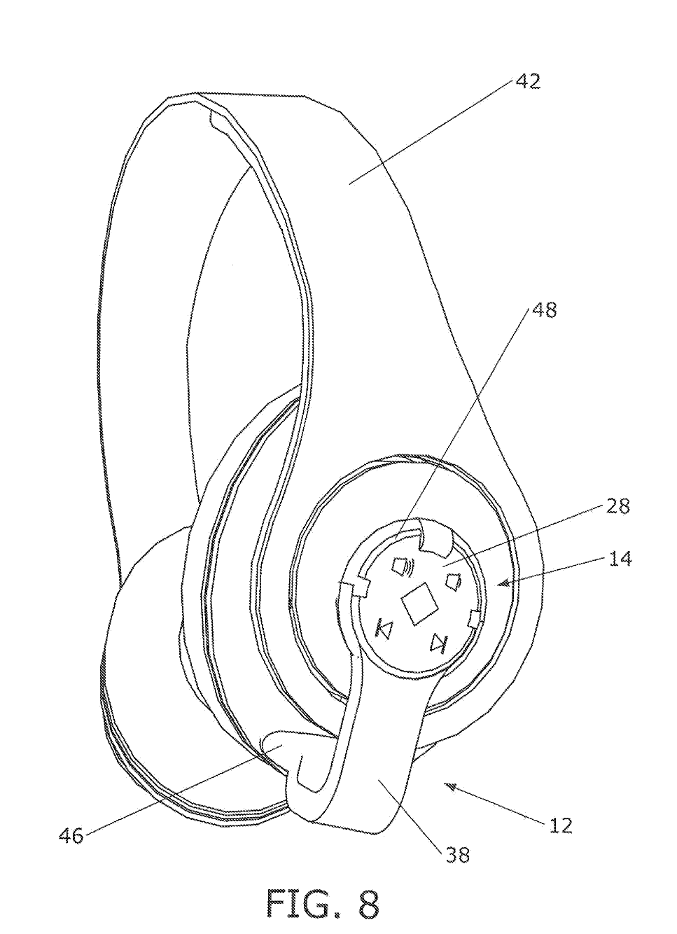

FIGS. 7 and 8 illustrate the attachment of holder 12 to headphones 42 (listening device). A broken line shows second connector 16 aligned with audio socket 44 of prior art headphones 42 in FIG. 7. Prior art headphones 42 (or headset) typically have a 3.5 mm audio socket. Thus, second connector 16 preferably an audio jack. Second connector 16 inputs into audio socket 44 in order to provide audio to headphones 42. In a connected position, shown in FIG. 8, audio socket connection point 46 is not readily visible. In the preferred embodiment, stem 38 of holder 12 fits cleanly around headphones 42 while main device 14 sits on the outside of one earphone. The user can easily access front panel 28 for controlling audio output device 50 (illustrated in FIG. 1).

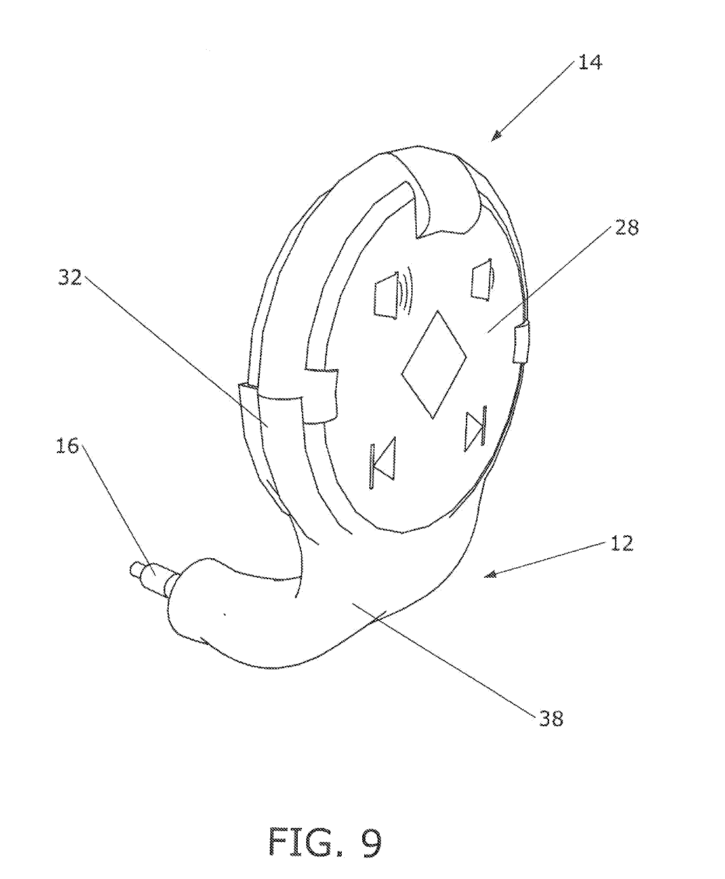

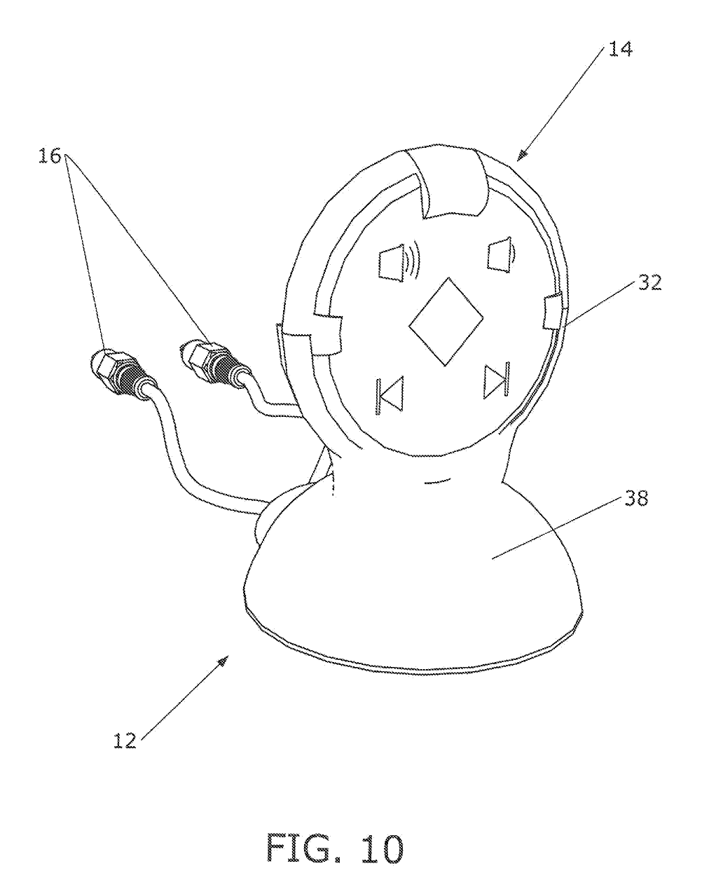

The reader will appreciate that although holder 12 is shown configured to attach to an existing headset or headphones, the present invention should not be limited to this embodiment. As an example, FIGS. 9 and 10 depict two different embodiments of holder 12. In FIG. 9, holder 12 is designed to attach to a vehicle auxiliary mount through second connector 16. In the embodiment illustrated, second connector 16 is an audio jack which connects to an auxiliary input socket, such as in a automobile.

In another embodiment of holder, shown in FIG. 10, holder 12 includes stem 38, support 32 and second connector 16. However, second connector 16 is a Dual RCA Stereo Audio connection cables. This type of connector allows for connection to a home audio mount. Similarly, second connector 16 could include a digital audio output (coaxial). Speakon connectors or other connector means.

The preceding description contains significant detail regarding the novel aspects of the present invention. It should not be construed, however, as limiting the scope of the invention but rather as providing illustrations of the preferred embodiments of the invention. Thus, the scope of the invention should be fixed by the following claims, rather than by the examples given.

Having described our invention, we claim:

1. A wireless audio system, for use with a listening device and an audio output device, comprising:
a. a main device capable of wirelessly connecting to said audio output device, said main device having,
i. a main body;
ii. a front panel attached to said main body;
ii. a chip configured to communicate with said audio output device; and
iii. a port attached to said main body;
b. a holder, capable of directly connecting to said main device, including,
i. a main portion having a support and a stem;
ii. a first connector capable of connecting to said port of said main device; and
iii. a second connector capable of connecting to said listening device; and
c. wherein said main device and said holder operate together to transmit audio from said audio output device to said listening device.

2. The wireless audio system as recited in claim 1, wherein said audio output device is a mobile phone.

3. The wireless audio system as recited in claim 1, wherein said front panel consists of a capacitive touch screen capable of controlling said audio output device through a signal connection.

4. The wireless audio system as recited in claim 1, wherein said front panel is a capacitive touch screen having a series of control functions.

5. The wireless audio system as recited in claim 1, wherein said front panel further includes a set of configurable LED lights.

6. The wireless audio system as recited in claim 1, wherein said listening device is a set of headphones.

7. The wireless audio system as recited in claim 1, wherein said listening device is a car stereo connected by way of an auxiliary input connection.

8. The wireless audio system as recited in claim 1, wherein said listening device is a speaker system.

9. The wireless audio system as recited in claim 1, wherein said main portion of said holder includes,
i. a support for supporting said main device in a connected position wherein said port is connected thereto; and
ii. a stem connected to said support.

10. The wireless audio system as recited in claim 1, wherein said main portion of said holder further includes a cup connected to said stem for attachment of said second connector.

11. The wireless audio system as recited in claim 9, wherein said support of said holder includes a channel capable of securely connecting said main device to said holder.

12. The wireless audio system as recited in claim 1, wherein said main device further includes at least two microphones.

13. A wireless audio system, for transmitting audio from an audio output device to a listening device, comprising:
a. a main device including,
i. a main body;
ii. a chip capable of connecting with said audio output device to receive audio;
iii. a front panel attached to said main body having a series of controls; and
iv. a port connected to said main body;
b. a holder, capable of attaching to said main device, including
i. a main portion having a support and a stem;
ii. a first connector attached to said support, wherein said first connector is configured to attach to said port of said main device; and
iii. a second connector attached to said stem, wherein said second connector is configured to attach to a listening device.

14. The wireless audio system as recited in claim 13, wherein said front panel is a capacitive touch screen.

15. The wireless audio system as recited in claim 13, wherein said main device further includes at least two noise-cancelling microphones.

16. The wireless audio system as recited in claim 13, wherein said support of said holder further includes a channel, wherein said channel securely connects said holder to said main device.

17. The wireless audio system as recited in claim 13, wherein said first connector is a mini USB connector.

18. The wireless audio system as recited in claim 13, wherein said second connector is an audio jack.

19. The wireless audio system as recited in claim 13, wherein said main device includes at least one LED light.

20. The wireless audio system as recited in claim 13, wherein said listening device is a set of headphones.
